(19) United States
(12) Patent Application Publication
(10) Pub. No.: US 2013/0233370 A1
(43) Pub. Date: Sep. 12, 2013

(54) DYE-SENSITIZED SOLAR CELL AND METHOD OF PREPARING THE SAME

(71) Applicant: DONGJIN SEMICHEM CO., LTD., Incheon (KR)

(72) Inventors: Chong-Chan Lee, Hwaseong (KR); Chan-Seok Park, Hwaseong (KR)

(73) Assignee: Dongjin Semichem Co., Ltd., Incheon (KR)

(21) Appl. No.: 13/871,733

(22) Filed: Apr. 26, 2013

Related U.S. Application Data
(63) Continuation of application No. PCT/KR2011/007991, filed on Oct. 25, 2011.

(30) Foreign Application Priority Data
Oct. 26, 2010 (KR) 10-2010-0104881
Oct. 25, 2011 (KR) 10-2011-0109091

(51) Int. Cl. H01G 9/20; H01G 9/00

(52) U.S. Cl. CPC H01G 9/20; H01G 9/0036; B82Y 20/00
USPC 136/244; 136/252; 438/70; 977/948; 977/842

(57) ABSTRACT

The invention relates to a dye-sensitized solar cell and a method of preparing the same, and it can increase the efficiency and productivity of dye-sensitized solar cells at the same time by replacing all or part of the expensive light-absorbing dyes by carbon nanotubes (CNT), graphenes or carbon blacks.

### CROSS-REFERENCES TO RELATED APPLICATIONS

This application is a continuation of International Application No. PCT/KR2011/007991 filed on Oct. 25, 2011, which claims priority to Korean Application No. 10-2010-0104881 filed on Oct. 26, 2010 and Korean Application No. 10-2011-0109091 filed on Oct. 25, 2011. The entire contents of the aforementioned patent applications are incorporated herein by this reference.

### TECHNICAL FIELD

The invention relates a dye-sensitized solar cell and a method of preparing the same and more particularly, it relates to a dye sensitized solar cell characterized by using a carbon nanotube (CNT), graphene or carbon black as a light-absorbing material and a method of preparing the same.

### BACKGROUND ART

Since a dye-sensitized solar cell based on titanium oxide nanoparticles was invented by Michael Gratzel, et., al, at EPFL in Lausanne, Switzerland in 1991, numerous researches on this field are currently going on. As the dye-sensitized solar cells have remarkably low manufacturing costs when compared with existing silicon type solar cells, they have a potential of replacing the existing amorphous silicon solar cells. Unlike the silicon solar cells, the dye-sensitized solar cell is a photo electrochemical solar cell comprising a dye molecule capable of generating an electron-hole pair by absorbing light, and a transition metal oxide which transfers the thus generated electron as main components.

FIG. 1 shows a structure of a general dye-sensitized solar cell and how electricity is generated therein.

With reference to FIG. 1, a dye-sensitized solar cell (10) may comprise glass substrates (11, 12) onto which transparent films (13, 14) are each adhered, a catalyst counter electrode (15), a working electrode (16) or photo electrode having a nanoparticle (TiO₂, titanium dioxide) structure, a dye (17), an electrolyte (18) and an encapsulant (19).

First, the dye-sensitized solar cell (10) is formed by filling the working electrode (16) having a nanoparticle structure in which a certain dye (17) is adsorbed and the electrolyte (18) between the two glass substrates (11, 12) on which the transparent films are each adhered. The transparent electrode films (13, 14) can be ATO, ITO or FTO, and they are usually provided in a state of being formed on the glass substrates (11, 12).

In particular, the dye-sensitized solar cell (10) is a cell which functions similarly to the mechanism of photosynthesis in plants, and it is a solar cell composed of a light-sensitive dye (17), a working electrode (16) which is a titania electrode of nano structure, an electrolyte (18), and a catalyst counter electrode (15). The dye-sensitized solar cell (10) does not use the conjugation of p type and n type semiconductors as in existing silicon solar cells or thin film solar cells and instead, it generates electricity by electrochemical principle, has high theoretical efficiency, and is environment-friendly so it is expected to be the most suitable solar cell as future green energy.

In the dye-sensitized solar cell (10), when external light is incident on the dye (17), the dye (17) generates an electron, which is then received by the working electrode (16) of multi-porous oxide semiconductors (mostly, TiO₂ is used) and transferred to the outside. Then, the electron flows via an external circuit and reaches the counter electrode (15). Meanwhile, in the dye (17) of the working electrode (16), since the electron is escaped to the outside, the dye (17) is provided with another electron from ions in the electrolyte (18), and the electron which is delivered to the counter electrode from the outside is transferred to the ions in the electrolyte (18), so that energy transferring process occurs consecutively.

The above process is resultant from the electrochemical reactions occurring between the working electrode (16) and the electrolyte (18) and between the counter electrode (15) and the electrolyte (18), and thus as an area in contact with the electrodes and electrolytes gets wider, more reaction can be carried out fast. Moreover, as a large amount of the dyes (17) can be adhered in proportion to the surface area of the working electrode (16), the amount of electricity to be produced increases. Hence, nanoparticles are used as materials for each electrode (15, 16) and thus, the surface area of materials in the same volume is drastically increased and a huge amount of the dyes can be thus adhered to the surface, thereby increasing the rate of the electrochemical reaction between the electrodes (15, 16) and the electrolyte (18). The dye-sensitized solar cell module is provided in a module form where a number of the dye-sensitized solar cells (10) are arranged in series or parallel.

In the above existing dye-sensitized solar cells, however, the light-absorbing dye (17) mostly absorbs only the visible ray region and its efficiency is thus low. Further, as the light-absorbing dyes are expensive, they become the main cause of increasing the manufacturing costs of dye-sensitized solar cells. Therefore, there are urgent demands on various methods capable of increasing the efficiency of dye-sensitized solar cells as well as lowering the manufacturing costs.

### SUMMARY

In order to solve the aforementioned problems, it is an object of the invention to provide a dye-sensitized solar cell which is capable for increasing the efficiency as a solar cell by expanding the region of light absorbing wavelength zone and is capable for remarkably reducing the manufacturing costs of solar cells by using an inexpensive light-absorbing material, and a method of preparing the same.

In order to achieve the above object, the present invention provides a dye-sensitized solar cell comprising a light-absorbing material, characterized in that the light-absorbing material comprises a carbon nanotube (CNT), graphene or carbon black.

Preferably, the light-absorbing material is characterized by comprising a) a light-absorbing dye and b) a carbon nanotube (CNT), graphene or carbon black.

Also, the present invention provides a method of preparing a dye-sensitized solar cell comprising the step of absorbing a light-absorbing material onto a working electrode, characterized in that the light-absorbing material comprises a carbon nanotube (CNT), graphene or carbon black.

Preferably, the light-absorbing material is characterized by comprising a) a light-absorbing dye and b) a carbon nanotube (CNT), graphene or carbon black.

In accordance with the invention, the efficiency of solar cells can be increased by employing a carbon nanotube (CNT), graphene or carbon black as a light-absorbing material to expand the region of light absorbing wavelength zone and the manufacturing costs can be remarkably reduced by employing an inexpensive light-absorbing material.

### BRIEF DESCRIPTION OF THE DRAWINGS

FIG. 1 shows a structure of a general dye-sensitized solar cell and how electricity is generated therein.

FIG. 2 shows how electricity is generated in a dye-sensitized solar cell in accordance with one embodiment of the present invention.

FIG. 3 shows a graph of short-circuit photocurrent density (Jsc) measured using the dye-sensitized solar cells prepared in Example 1 of the present invention and Comparative Example.

### DETAILED DESCRIPTION

Hereafter, the present invention is described in detail. Throughout the entire specification, the term “comprising” means to be able to further comprise other elements without excluding the other elements unless specifically stated otherwise.

The invention provides a dye-sensitized solar cell comprising a light-absorbing material, characterized in that the light-absorbing material comprises a carbon nanotube (CNT), graphene or carbon black. The light-absorbing material is preferably a carbon nanotube (CNT) and more preferably, a single-walled carbon nanotube (CNT).

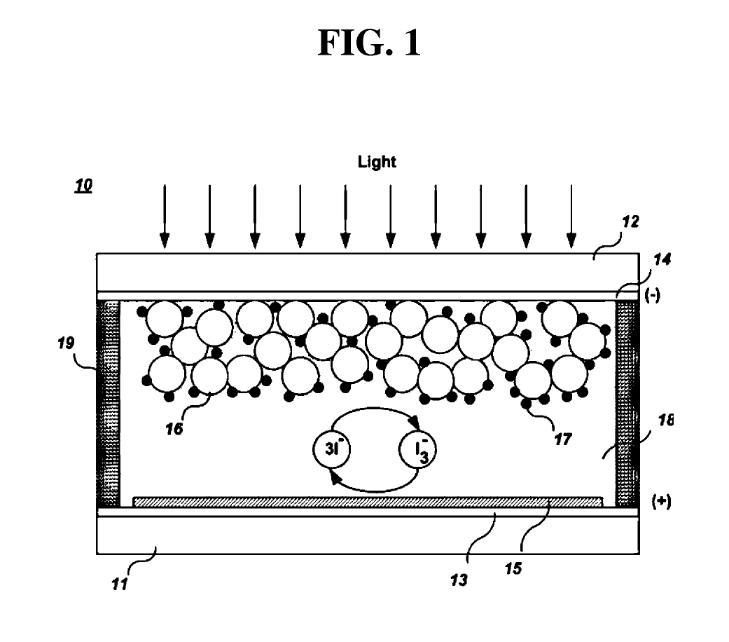

For other elements of the dye-sensitized solar cells except the light-absorbing material which is a carbon nanotube (CNT), graphene or carbon black in accordance with the invention, it is understood that there can be used any known elements of conventional dye-sensitized solar cells where the dye is used for a sole light-absorbing material. As a specific example, a dye-sensitized solar cell module may be a structure comprising a working electrode substrate where a working electrode (photo electrode) having a multi-porous oxide semiconductive layer (usually, multi-porous TiO₂) on which light-absorbing materials are adsorbed is formed on a first transparent glass substrate; a counter electrode substrate which is laminated with the working electrode substrate and wherein a catalyst counter electrode is formed on a second transparent glass substrate; and an electrolyte which is injected into the inside of the laminated counter electrode substrate and working electrode substrate, as shown in FIG. 1. It may further a light scattering layer on the working electrode. In this structure, it is understood that there can be used any known dyes for dye-sensitized solar cells such as a ruthenium-based dye or an organic dye.

In accordance with the present invention, the carbon nanotubes (CNT), graphenes or carbon blacks absorb light and transfer an electron to the working electrode and thus they exhibit mechanism equivalent to the light-absorbing dyes of existing dye-sensitized solar cells.

It is preferable that the carbon nanotubes (CNT), graphenes or carbon blacks in the invention have a particle size of 0.01 to 100 nm. Within the above ranges, the carbon nanotubes (CNT), graphenes or carbon blacks are able to absorb light from ultra-violet ray region to infrared ray region of dye-sensitized solar cells to generate an electron and in particular, as the particle size gets smaller, they can absorb light in shorter wavelength zone (ultra-violet ray region) and as the particle size gets larger, they can absorb light in longer wavelength zone (infrared ray region). Hence, when the carbon nanotubes (CNT), graphenes or carbon blacks are adsorbed on the multi-porous oxide semiconductors, it is advantageous to variously distribute the size of the particles.

Also, in accordance with the present invention, the carbon nanotubes (CNT), graphenes or carbon blacks can be adsorbed on the working electrodes through chemical bonding or physical bonding, and for the chemical bonding, a wet coating can be applied and for the physical bonding, any known methods such as CVD (chemical vapor deposition) or ALD (atomic layer deposition) can be applied. Further, for the chemical bonding, the carbon nanotubes (CNT), graphenes or carbon blacks can be attached with an anchoring group at their terminal group and as specific examples of the anchoring group, there can be used those having the following structures. Preferably, one carbon nanotube (CNT), graphene or carbon black may have 1 to 100 anchoring groups.

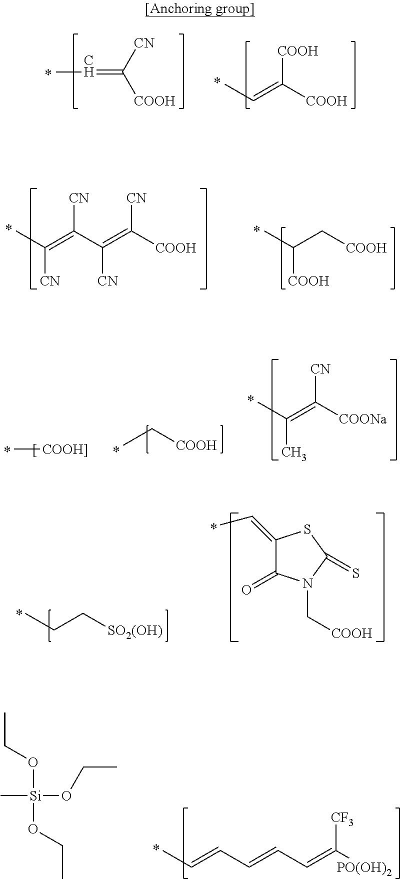

Further, the carbon nanotubes (CNT), graphenes or carbon blacks of the invention may further comprise an electron group or light absorption pendant at their terminal and thus further improve the efficiency of the dye-sensitized solar cells. For the electron group or light absorption pendant, there can be any known electron groups or light absorption pendants and for example, a substituted or unsubstituted aryl group of C6-C50 or a substituted or unsubstituted alkyl group of C1-C30. Also, one carbon nanotube, graphene or carbon black may have a various number (ex., 1 to 100) of the electron groups or light absorption pendants.

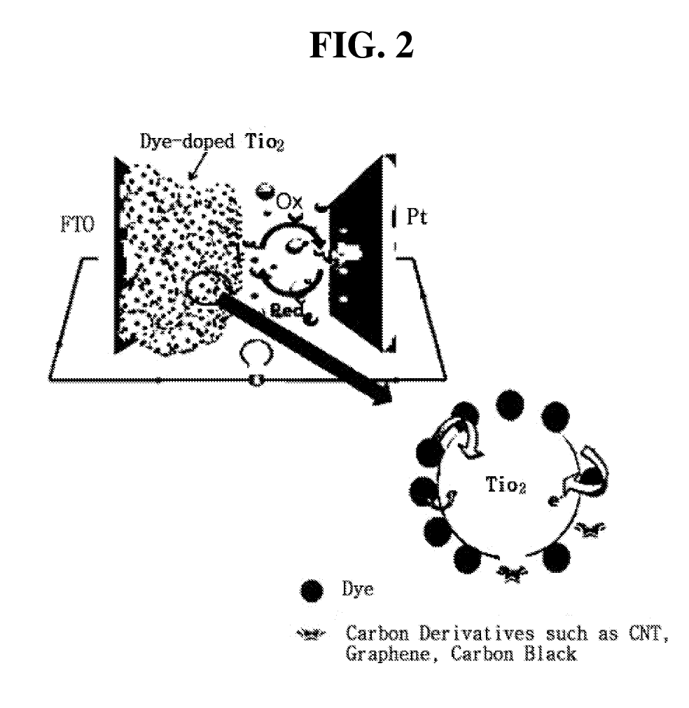

Also, in accordance with the dye-sensitized solar cells of the invention, the light-absorbing material adsorbed on the multi-porous oxide semiconductors can be a) a light-absorbing dye and b) a carbon nanotube (CNT), graphene or carbon black. FIG. 2 illustrates how the dye-sensitized solar cell of the invention works. In this structure, a) the light-absorbing dye can absorb light in visible ray region and b) the carbon nanotube (CNT), graphene or carbon black can absorb light in ultra-violet ray and infrared ray region. The amount of a) the light-absorbing dye and b) the carbon nanotube (CNT), graphene or carbon black adsorbed on the multi-porous oxide semiconductors can be optionally adjusted and for instance, the light-absorbing material can comprise 30 to 70% by weight of a) the light-absorbing dye and 30 to 70% by weight of b) the carbon nanotube (CNT), graphene or carbon black. Preferably, it is advantageous with regard to 100% by weight of b) the carbon nanotube (CNT), graphene or carbon black to comprise those having a particle size of 0.01 to 2 nm in an amount of 20 to 80% by weight and those having a particle size of 2 to 100 nm in an amount of 20 to 80% by weight so as to evenly absorb light in various wavelength zone. For a) the light-absorbing dye, it is understood that there can be applied a various kinds of dyes that can be used in dye-sensitized solar cells, and any ruthenium-based or organic dyes are applicable.

As stated in the above, the present invention has merits in that it can expand the region of light-absorbing wavelength zone and drastically lower the manufacturing costs by replacing all or part of the expensive light-absorbing dye of the dye-sensitized solar cells which solely used the light-absorbing dye as a light-absorbing material, by the carbon nanotubes (CNT), graphenes or carbon blacks.

Also, the present invention provides a method of preparing a dye-sensitized solar cell comprising the step of absorbing a light-absorbing material onto a working electrode, characterized in that the light-absorbing material comprises a carbon nanotube (CNT), graphene or carbon black. The light-absorbing material is preferably a carbon nanotube (CNT) and more preferably, a single-walled carbon nanotube.

For other steps of the method of preparing dye-sensitized solar cells except the adsorption of the light-absorbing material on a working electrode in accordance with the invention, it is understood that there can be used any known preparation methods for dye-sensitized solar cells using a dye. As a specific example, they can be carried out by comprising the steps of a) preparing a working electrode substrate where a working electrode having a multi-porous oxide semiconductive layer on which light-absorbing materials are adsorbed is formed on a first transparent glass substrate; b) preparing a counter electrode substrate where a catalyst counter electrode is formed on a second transparent glass substrate; c) laminating the counter electrode substrate and the working electrode substrate; and d) inserting an electrolyte into the laminated counter electrode substrate and working electrode substrate.

In the above, the step of a) preparing a working electrode substrate can be carried out by comprising the steps of a-1) forming a first transparent electrode on the first transparent glass substrate; a-2) forming a multi-porous oxide semiconductive layer on the first transparent electrode; and a-3) absorbing a light-absorbing material to the multi-porous oxide semiconductive layer. Also, a light scattering layer can be further comprised on the working electrode.

It is advantageous with regard to 100% by weight of b) the carbon nanotube (CNT), graphene or carbon black to be adsorbed to comprise those having a particle size of 0.01 to 2 nm in an amount of 20 to 80% by weight and those having a particle size of 2 to 100 nm in an amount of 20 to 80% by weight so as to evenly absorb light in various wavelength zone.

Also, in accordance with the present invention, the carbon nanotubes (CNT), graphenes or carbon blacks can be adsorbed on the working electrodes through chemical bonding or physical bonding, and for the physical bonding, any known methods such as CVD (chemical vapor deposition) or ALD (atomic layer deposition) can be applied. For the chemical bonding, the carbon nanotubes (CNT), graphenes or carbon blacks can be attached with an anchoring group at their terminal group.

Further, the carbon nanotubes (CNT), graphenes or carbon blacks of the invention may further comprise an electron group or light absorption pendant at their terminal and thus further improve the efficiency of the dye-sensitized solar cells.

Also, in accordance with the method of preparing dye-sensitized solar cells of the invention, the light-absorbing material to be adsorbed on the multi-porous oxide semiconductors can be a) a light-absorbing dye such as a ruthenium-based dye or an organic dye and b) a carbon nanotube (CNT), graphene or carbon black. The amount of a) the light-absorbing dye and b) the carbon nanotube (CNT), graphene or carbon black adsorbed on the multi-porous oxide semiconductors can be optionally adjusted and in particular, the light-absorbing material can comprise 30 to 70% by weight of a) the light-absorbing dye and 30 to 70% by weight of b) the carbon nanotube (CNT), graphene or carbon black. Preferably, it is advantageous with regard to 100% by weight of b) the carbon nanotube (CNT), graphene or carbon black to comprise those having a particle size of 0.01 to 2 nm in an amount of 20 to 80% by weight and those having a particle size of 2 to 100 nm in an amount of 20 to 80% by weight so as to evenly absorb light in various wavelength zone. For a) the light-absorbing dye, it is understood that there can be applied a various kinds of dyes that can be used in dye-sensitized solar cells, and any ruthenium-based or organic dyes are applicable.

Also, the adsorption method and order of a) the light-absorbing dye and b) the carbon nanotube (CNT), graphene or carbon black to be adsorbed on the multi-porous oxide semiconductors can be optionally adjusted. For instance, the light-absorbing dye can be first adsorbed and then followed by the adsorption of the carbon nanotubes and so on; the carbon nanotubes and so on can be first adsorbed and then followed by the adsorption of the light-absorbing dye; or carbon nanotubes and so on having a large particle size can be first adsorbed and then followed by the adsorption of the light-absorbing dye and then by the adsorption of carbon nanotubes and so on having a small particle size. It is understood that when the carbon nanotubes (CNT), graphenes or carbon blacks are adsorbed, chemical bonding or physical bonding can be suitably selected and preferably, it is advantageous for the efficiency of adsorption and stability to perform chemical bonding when the carbon nanotubes (CNT), graphene or carbon blacks are adsorbed after the adsorption of the light-absorbing dyes.

The method of preparing dye-sensitized solar cells in accordance with the present invention has merits in that they are able to drastically lower the manufacturing costs by replacing all or part of the expensive light-absorbing dyes by inexpensive carbon nanotubes (CNT), graphenes or carbon blacks.

For better understanding of the present invention, preferred embodiments follow. The following examples should be understood to merely illustrate the invention without limiting the scope of the invention.

### EXAMPLES

### Example 1

### Preparation of Dye-Sensitized Solar Cell

A solar cell was prepared using a 12 μm TiO₂ transparent layer as the photo electrode. The TiO₂ transparent layer in a thickness of 8 μm was prepared by screen printing of a TiO₂ paste (Solaronix, 13 nm paste) and then impregnated in a dye solution where ruthenium-based dye was dissolved in ethanol at 0.5 nM to absorb the dye in the TiO₂ transparent layer.

After then, SWCNT (single-walled CNT) substituted with COOH at its terminal was prepared in a dimethylformamide solvent at a concentration of 0.01 mM and then adsorbed on the TiO₂ transparent layer which was already adsorbed by the ruthenium-based dye.

A high-temperature molten film (Surlyn 1702, 25 μm thickness) was disposed as a spacer between the TiO₂ electrode adsorbed by the dye and SWCNT and the platinum-counter electrode and heated to combine sealed sandwich electrodes. For the electrolyte solution, a mixture solution of 1-methyl-3-propylimidazolium iodide (MPII, 0.8 M), I2 (0.04 M), guanidium thiocyanate (GSCN, 0.05 M) and tert-butylpyridine (TBP, 0.5 M) dissolved in 3-methoxypropionitrile (MPN) was used.

### Example 2

### Preparation of Dye-Sensitized Solar Cell

A dye-sensitized solar cell was prepared using the same method as Example 1 with the exception that instead of SWCNT (single-walled CNT) substituted with COOH at its terminal, a graphene substituted with COOH at its terminal was prepared in a dimethylformamide solvent at a concentration of 0.01 mM and the thus prepared graphene was adsorbed on the TiO₂ transparent layer which was already adsorbed with the ruthenium-based dye.

### Example 3

### Preparation of Dye-Sensitized Solar Cell

A dye-sensitized solar cell was prepared using the same method as Example 1 with the exception that instead of SWCNT (single-walled CNT) substituted with COOH at its terminal, a carbon black substituted with COOH at its terminal was prepared in a dimethylformamide solvent at a concentration of 0.01 mM and the thus prepared carbon black was adsorbed on the TiO₂ transparent layer which was already adsorbed with the ruthenium-based dye.

### Comparative Example

### Preparation of Dye-Sensitized Solar Cell

A dye-sensitized solar cell was prepared using the same method as Example 1 with the exception that the SWCNT (single-walled CNT) substituted with COOH at its terminal was not used.

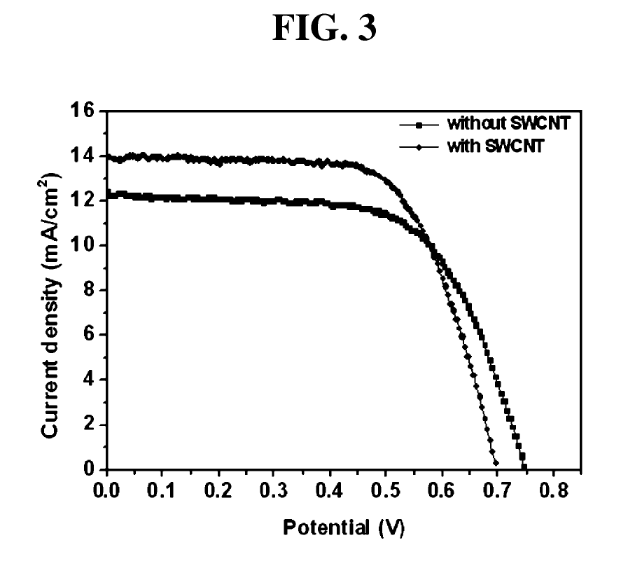

With regard to the dye-sensitized solar cells prepared in Example 1 and Comparative Example, their short-circuit photocurrent density (J_{sc}), open circuit photovoltage (V_{oc}), and fill factor (FF) were measured and shown in Table 1 below and FIG. 3.

TABLE 1

| Dye | J_{sc} (mA/cm²) | V_{oc} (V) | FF | η (%) |
|---|---|---|---|---|
| Comparative | 12.25 | 0.74 | 0.63 | 5.72 |
| Example | | | | |
| Example 1 | 14.10 | 0.69 | 0.64 | 6.24 |

As shown in Table 1 above and FIG. 3, it can be seen that Example 1 where the carbon nanotube was used as a light-absorbing material exhibited a particularly high Jsc value as well as improvement in overall efficiency when compared with Comparative Example where the carbon nanotubes were not used as a light-absorbing material.

Moreover, as the efficiencies of the dye-sensitized solar cells prepared in Example 2 and Example 3 indicated 6.14% and 6.03%, respectively, it was verified that they resulted in efficiency improvement by at least 5% in comparison with the dye-sensitized solar cell where the graphenes or carbon blacks were not used.

The foregoing description of the invention is to illustrate the invention and those having ordinary knowledge in the pertinent art would understand that the invention may be easily modified into other specific forms without altering the spirit and essential features of the present invention. Therefore, it is to be understood that the examples described in the above are to illustrate and not to limit the invention in every aspect. For example, each element described in a single form may be performed while being dispersed and elements described as those to be dispersed may be performed in a combined form.

It is to be interpreted that the scope of the invention is defined by the following claims rather than the above detailed description and all the modifications and alterations derived from the meaning and scope of the claims and their equivalent concept are still within the scope of the invention.

In accordance with the invention, the efficiency of solar cells can be increased by employing a carbon nanotube (CNT), graphene or carbon black as a light-absorbing material to expand the region of light absorbing wavelength zone and the manufacturing costs can be remarkably reduced by employing an inexpensive light-absorbing material.

1. A dye-sensitized solar cell comprising a light-absorbing material, characterized in that the light-absorbing material comprises a carbon nanotube (CNT), graphene or carbon black.

2. The dye-sensitized solar cell according to claim 1, characterized in that the light-absorbing material is a single-walled carbon nanotube having a particle size of 0.01 to 100 nm.

3. The dye-sensitized solar cell according to claim 1, characterized in that the light-absorbing material comprises
a) a light-absorbing dye; and
b) a carbon nanotube (CNT), graphene or carbon black.

4. The dye-sensitized solar cell according to claim 3, characterized in that the light-absorbing material comprises
a) 30 to 70% by weight of a light-absorbing dye; and
b) 30 to 70% by weight of a carbon nanotube (CNT), graphene or carbon black.

5. The dye-sensitized solar cell according to claim 1, characterized in that the carbon nanotube (CNT), graphene or carbon black has an anchoring group.

6. The dye-sensitized solar cell according to claim 1, characterized in that the carbon nanotube (CNT), graphene or carbon black has an electron donor group or a light absorption pendant.

7. A method of preparing a dye-sensitized solar cell comprising the step of absorbing a light-absorbing material onto a working electrode, characterized in that the light-absorbing material comprises a carbon nanotube (CNT), graphene or carbon black.

8. The dye-sensitized solar cell according to claim 7, characterized in that the light-absorbing material is a single-walled carbon nanotube having a particle size of 0.01 to 100 nm.

9. The method of preparing the dye-sensitized solar cell according to claim 7, characterized in that the light-absorbing material comprises
a) a light-absorbing dye; and
b) a carbon nanotube (CNT), graphene or carbon black.

10. The method of preparing the dye-sensitized solar cell according to claim 9, characterized in that the light-absorbing material comprises
a) 30 to 70% by weight of a light-absorbing dye; and
b) 30 to 70% by weight of a carbon nanotube (CNT), graphene or carbon black.

11. The method of preparing the dye-sensitized solar cell according to claim 7, characterized in that the carbon nanotube (CNT), graphene or carbon black has an anchoring group.

12. The method of preparing the dye-sensitized solar cell according to claim 7, characterized in that the carbon nanotube (CNT), graphene or carbon black has an electron donor group or a light absorption pendant.

13. A dye-sensitized solar cell module comprising the dye-sensitized solar cell of claim 1.
